(19) United States
(12) Patent Application Publication
(10) Pub. No.: US 2026/0367988 A1
(43) Pub. Date: Nov. 19, 2026

(54) Dynamic Hierarchical Workload-Driven Control of Frequency Utilization Applicable to a System-on-Chip (SOC) Environment

(71) Applicant: Google LLC, Mountain View, CA (US)

(72) Inventors: Mohsen Heidarinejad, San Jose, CA (US); Farid Kenarangi, Milpitas, CA (US); Arpit Mittal, San Jose, CA (US); Amin Djahromi Khajeh, Los Altos Hills, CA (US)

(73) Assignee: Google LLC, Mountain View, CA (US)

(21) Appl. No.: 19/730,496

(22) Filed: Jul. 2, 2026

(51) Int. Cl. G06F 9/50

(52) U.S. Cl. CPC G06F 9/505

(57) ABSTRACT

Modern computing systems dynamically adjust hardware operation points to balance performance against power and thermal limitations. However, purely reactive power and thermal mitigation mechanisms can respond too slowly to sudden workload demands or prematurely throttle processing speeds based on static safety thresholds. To address these issues, a hierarchical, multi-time-scale control architecture can decouple high-speed, proactive workload-driven scaling from slower, reactive physical constraint scaling. In example implementations, an apparatus obtains a workload demand for a hardware subsystem and uses a fast control loop to generate a first candidate operation point. The apparatus also obtains physical operating parameters and uses a slower control loop to generate a second candidate operation point. The apparatus then arbitrates between multiple candidate operation points to select an execution operation point, proactively prioritizing the first candidate operation point. This architecture decreases execution latency for bursty workloads while safely enforcing physical boundaries and protecting hardware reliability.

### SUMMARY

Modern computing systems and mobile devices may encounter challenges when balancing transient computational bursts with physical hardware constraints. Purely reactive power and thermal mitigation mechanisms can respond too slowly to sudden workload demands or can prematurely throttle processing speeds based on static safety thresholds, which may result in increased execution latency. To mitigate these issues, this document describes a hierarchical, multi-time-scale control architecture that can decouple proactive, high-speed workload-driven performance scaling from reactive, slower-speed physical constraint scaling. This decoupled approach may ensure that sufficient computational resources are dedicated to latency-sensitive tasks while simultaneously enforcing physical safety and long-term reliability parameters.

In example implementations, an electronic device can utilize multiple control loops operating concurrently at different time scales to generate candidate operation points for a hardware subsystem. For instance, a fast performance detection loop may operate at a microsecond time scale to quickly evaluate application-provided workload demands and generate a first candidate operation point. Meanwhile, one or more slower control loops can monitor physical operating parameters to propose other candidate operation points. These slower loops may evaluate aspects like a power consumption envelope over a sliding time window, an instantaneous or filtered thermal rate, and long-term cumulative operational-stress data associated with an expected multi-year lifespan.

A prioritization system, or arbiter thereof, may then arbitrate between these multiple candidate operation points to select an execution operation point, like a target voltage or a target frequency. To capture transient workload bursts without undue throttling, the arbiter can prioritize the workload-driven candidate over the physically constrained candidates. This prioritization may incorporate smart safety overrides. As an example, the arbiter may apply an aggressive target frequency that mathematically violates a steady-state thermal safety threshold if a predictive thermal model indicates that a short burst can safely complete before a physical thermal effect manifests. Furthermore, the architecture may use asymmetric scaling, where upward operation point adjustments are unfiltered and permitted to unfold quickly, while downward adjustments are filtered such that a sustained downward trend occurs prior to generating a reduced candidate operation point.

In example implementations, an apparatus for hierarchical workload-driven control of dynamic operation-point adjustments is described. The apparatus includes at least one memory having processor-executable instructions and one or more processors. By executing the processor-executable instructions to cause the apparatus to perform operations, the one or more processors are configured to obtain at least one workload demand associated with a workload executing on a hardware subsystem. The one or more processors are also configured to generate, by a first control loop operating at a first time scale, a first candidate operation point based on the at least one workload demand. The one or more processors are additionally configured to obtain one or more physical operating parameters associated with the hardware subsystem. The one or more processors are further configured to generate, by a second control loop operating at a second time scale that is slower than the first time scale, a second candidate operation point based on the one or more physical operating parameters. Additionally, the one or more processors are configured to arbitrate between multiple candidate operation points, including at least the first candidate operation point and the second candidate operation point, to select an execution operation point, with the arbitrating including prioritizing the first candidate operation point over the second candidate operation point. The one or more processors are further configured to apply the execution operation point to the hardware subsystem.

In example implementations, a method for hierarchical workload-driven control of dynamic operation-point adjustments is described. The method includes obtaining at least one workload demand associated with a workload executing on a hardware subsystem. The method also includes generating, by a first control loop operating at a first time scale, a first candidate operation point based on the at least one workload demand. The method additionally includes obtaining one or more physical operating parameters associated with the hardware subsystem. The method further includes generating, by a second control loop operating at a second time scale that is slower than the first time scale, a second candidate operation point based on the one or more physical operating parameters. The method also includes arbitrating between multiple candidate operation points including at least the first candidate operation point and the second candidate operation point to select an execution operation point, with the arbitrating including prioritizing the first candidate operation point over the second candidate operation point. The method further includes applying the execution operation point to the hardware subsystem.

In example implementations, a computer program product for hierarchical workload-driven control of dynamic operation-point adjustments is described. The computer program product includes at least one computer-readable storage medium having computer-executable instructions stored thereon that, when executed by one or more processors, cause an apparatus to perform operations. The operations include obtaining at least one workload demand associated with a workload executing on a hardware subsystem. The operations also include generating, by a first control loop operating at a first time scale, a first candidate operation point based on the at least one workload demand. The operations additionally include obtaining one or more physical operating parameters associated with the hardware subsystem. The operations further include generating, by a second control loop operating at a second time scale that is slower than the first time scale, a second candidate operation point based on the one or more physical operating parameters. The operations also include arbitrating between multiple candidate operation points including at least the first candidate operation point and the second candidate operation point to select an execution operation point, including prioritizing the first candidate operation point over the second candidate operation point. The operations further include applying the execution operation point to the hardware subsystem.

These and other example implementations are described further herein.

### BRIEF DESCRIPTION OF DRAWINGS

Apparatuses of and techniques for dynamic and hierarchical workload-driven control of frequency utilization, which are usable in a system-on-chip (SoC) environment, are described with reference to the following drawings. The same numbers are used throughout the drawings to reference the same or similar features and components.

FIG. 1 illustrates an example apparatus with a prioritization system that can implement hierarchical workload-driven control of dynamic operation-point adjustments.

FIG. 2 illustrates example implementations of hierarchical workload-driven control of dynamic operation-point adjustments in the context of a multi-control-loop environment that can operate at different time scales.

FIG. 3 illustrates example prioritization systems that can implement hierarchical workload-driven control of dynamic operation-point adjustments using multiple control loops and an arbiter.

FIG. 4 depicts three graphs with a common time axis to illustrate example prioritization control aspects of hierarchical workload-driven control of dynamic operation-point adjustments.

FIGS. 5, 5-1, and 5-2 illustrate other example prioritization systems that can implement hierarchical workload-driven control of dynamic operation-point adjustments using multiple example control loops, an operation point unit, and multiple signaling examples.

FIG. 6 is a flow diagram illustrating example processes for hierarchical workload-driven control of dynamic operation-point adjustments.

FIG. 7 illustrates various components of an example electronic device that can implement hierarchical workload-driven control of dynamic operation-point adjustments in accordance with one or more described aspects.

### DETAILED DESCRIPTION

### Overview

Computing devices, like smartphones, constantly balance delivering high processing performance with managing physical constraints like heat generation and battery drain. Some strategies for managing this balance rely on reactive power and thermal mitigation policies. These systems monitor temperature or power consumption and then throttle the hardware when certain thresholds are reached. Alternatively, strategies that rely on fixed mitigation policies can treat all usage scenarios the same regardless of what a user is doing. Relying primarily on these slower, reactive feedback mechanisms can cause a device to miss performance targets, especially for sudden, intensive computational bursts. Missing these performance targets ultimately leads to increased execution latency that manifests in slower application response times.

This document describes hardware and techniques that implement hierarchical workload-driven control of dynamic operation-point adjustments, which can include frequency utilization in a system-on-chip (SoC) environment. The hardware and techniques can be implemented in, for instance, systems that employ dynamic voltage and frequency scaling (DVFS). By decoupling proactive, high-speed workload-driven performance scaling from reactive, slower-speed physical constraint scaling, an apparatus can respond appropriately to sudden workload demands. A prioritization system, which can include an arbiter or operation point unit, evaluates candidate operation points from these decoupled control loops, but the prioritization system prioritizes the rapid workload demands subject to intelligent safety overrides. This hierarchical methodology decreases processing latency and readily handles bursty workloads without compromising device safety or long-term reliability.

To implement this decoupled approach, an apparatus obtains at least one workload demand associated with a workload executing on a hardware subsystem. A workload demand can include application-provided metadata, like an explicit minimum frequency requirement, a quality-of-service (QoS) hint, or a target workload completion time. A first control loop operating at a fast, first time scale generates a first candidate operation point based on the at least one workload demand. A candidate operation point may include at least one of a target voltage or a target frequency for the hardware subsystem.

Distinct from obtaining the workload demand, the apparatus obtains one or more physical operating parameters associated with the hardware subsystem, like a power consumption parameter, a temperature parameter, or cumulative operational-stress data of the hardware subsystem. A second control loop operating at a second time scale that is slower than the first time scale generates a second candidate operation point based on the one or more physical operating parameters. For example, the second control loop may generate the second candidate operation point based on a rate of change of the temperature parameter. The temperature parameter may correspond to an instantaneous junction temperature of the hardware subsystem or a filtered enclosure temperature of the apparatus. The apparatus can also execute more than two control loops for a given hardware subsystem.

The apparatus then arbitrates between multiple candidate operation points, including at least the first candidate operation point and the second candidate operation point, to select an execution operation point. As used herein, arbitrating “between” multiple items is not limited to exactly two items. Instead, the term “between” may encompass arbitrating among two, three, four, or more candidate operation points. During this arbitration, the operation point unit prioritizes the first candidate operation point over the second candidate operation point. The selected execution operation point may also include at least one of a target voltage or a target frequency for the hardware subsystem. The apparatus then applies the execution operation point to the hardware subsystem to increase or decrease the processing resources available to the hardware subsystem.

Various implementations can dynamically handle diverse usage scenarios. For example, when a user initially launches an application, they may experience a noticeable user-interface lag if the device relies on sluggish reactive scaling. To combat this, the first control loop can employ asymmetric scaling. Here, the apparatus generates an increased first candidate operation point based on an upward operation point adjustment without applying a filtering profile to rapidly enable workload bursts. Conversely, the apparatus applies a filtering profile to a downward operation point adjustment to ensure a sustained downward trend occurs prior to generating a reduced first candidate operation point. Alternatively, the apparatus can apply an upward filtering profile that generously increases a candidate operation point and a downward filtering profile that resists decreasing a candidate operation point.

As another example, the apparatus can determine at least one target performance criterion (e.g., computational goal) based on the at least one workload demand. The apparatus then obtains one or more computation metrics associated with the hardware subsystem to perform a “plausibility check.” During this check, the apparatus evaluates whether a proposed operation point satisfies the target performance criterion in view of the computation metrics. In contrast with workload demands, these computation metrics can be strictly defined as measured, hardware-generated telemetry data, like a run-queue occupancy, an instruction-per-cycle (IPC) degradation metric, a cache-access rate, a pipeline-stall behavior, a wake-up event, an interrupt arrival, and so forth. For instance, if the computation metrics reveal a severe memory bottleneck, proposing a higher processor frequency will not satisfy the target performance criteria, so the prioritization system can adjust the generation of the candidate operation point accordingly.

Other slower control loops manage the physical boundaries of the device. Because different applications have varying sustained power demands, handling a sustained video call utilizes a different mitigation approach than handling light text messaging. To manage these different power demands, the second control loop can operate as a power rate control loop that filters the power consumption parameter over a sliding time window. This filtering can apply, for instance, an exponential moving average to isolate a sustained computational demand from transient power bursts. The apparatus can compare the resulting power consumption envelope to multiple predefined power tiers and adjust the second candidate operation point based on the comparison. The apparatus may also enforce a hysteresis buffer between adjacent power tiers of the multiple predefined power tiers to prevent oscillatory operation-point transitions.

In some situations, prioritizing the fast, workload-driven candidate operation point may propose an aggressive target frequency that violates a safety threshold associated with one or more obtained physical operating parameters. The operation point unit can respond by overriding the prioritizing of the first candidate operation point over the second candidate operation point based on the safety threshold being violated. To address this intelligently, the operation point unit can, for example, incorporate a predictive thermal bypass. To do so, the operation point unit generates, using a predictive thermal model, a prediction of expected temperature behavior for the hardware subsystem based on the first candidate operation point.

If the prediction of expected temperature behavior indicates no violation of the safety threshold over a duration of the workload, the operation point unit bypasses the overriding of the prioritizing of the first candidate operation point over the second candidate operation point based on the prediction of expected temperature behavior. This bypassing of the overriding occurs based on the duration of the workload being shorter than a time period involved to observe a relevant physical thermal effect resulting from applying, on the hardware subsystem, the first candidate operation point as the execution operation point. This exception, which may last microseconds, permits high-speed execution for relatively minor, latency-sensitive workloads that would otherwise be rejected by strict thermal safety rules.

To manage long-term reliability, the hierarchical architecture can employ an additional control loop operating at a macro time scale that is slower than the second time scale. Over an expected multi-year lifespan of the hardware subsystem, continuous high-voltage or high-temperature operation can physically degrade silicon components. The macro control loop addresses this by generating an additional candidate operation point based on long-term cumulative operational-stress data of the hardware subsystem. The apparatus tracks a respective residency duration for each of multiple historical operation points of the hardware subsystem. In some cases, the apparatus applies a stress weight to each historical operation point of the multiple historical operation points based on at least one of an associated historical voltage or an associated historical temperature. This stress weight can correspond to a physical silicon-degradation model.

To use the stress weight in an operation point computation, the apparatus can scale the stress weight non-linearly based on the associated historical voltage or the associated historical temperature. By calculating the long-term cumulative operational-stress data via integrating the stress weight of each historical operation point over the corresponding respective residency duration, the apparatus can monitor device health. If this cumulative operational-stress data exceeds a target degradation threshold associated with the expected multi-year lifespan, the apparatus applies a progressive bias in favor of one or more down-scaling decisions or enforces a maximum available operation-point cap. Although the performance of a device may decrease over its three-to-five year lifespan, the reliability of the silicon is protected to ensure that the hardware does not fail prematurely.

Furthermore, implementations of this control architecture are highly modular. The control circuitry, which may collectively include a memory having processor-executable instructions and one or more processors, can instantiate the control loops independently for different hardware subsystems. For example, alongside executing control loops for a first hardware subsystem of a system-on-chip (SoC), the apparatus can be independently executing an instance of the first control loop, an instance of the second control loop, and an instance of the arbitrating between the multiple candidate operation points for a second hardware subsystem of the SoC. These hardware subsystems may include a central processing unit (CPU), a graphics processing unit (GPU), an artificial intelligence (AI) accelerator, a memory-access path or interconnect, and so forth. A single subsystem can also run multiple concurrent performance detection loops. For example, a first performance detection loop configured for microsecond burst workloads can operate concurrently at the first time scale alongside a second performance detection loop configured for sustained workloads to generate an extra candidate operation point. The operation point unit then arbitrates between the multiple candidate operation points, including the extra candidate operation point.

By proactively prioritizing workload demands while conditionally bypassing conservative thermal limits for short bursts, the architecture appreciably decreases execution latency. The asymmetric scaling approach enables transient computational bursts to proceed quickly, which prevents processing bottlenecks during sudden workload shifts. Further, by evaluating hardware-based computation metrics alongside software-based workload demands, the system avoids wasting power on frequency increases that would not actually accelerate the workload. Ultimately, the multiple decoupled time scales provide high-speed execution responsiveness alongside rigorous short-term and long-term hardware preservation. These and other example implementations, techniques, operations, and advantages are described herein.

### Example Environments and Electronic Devices

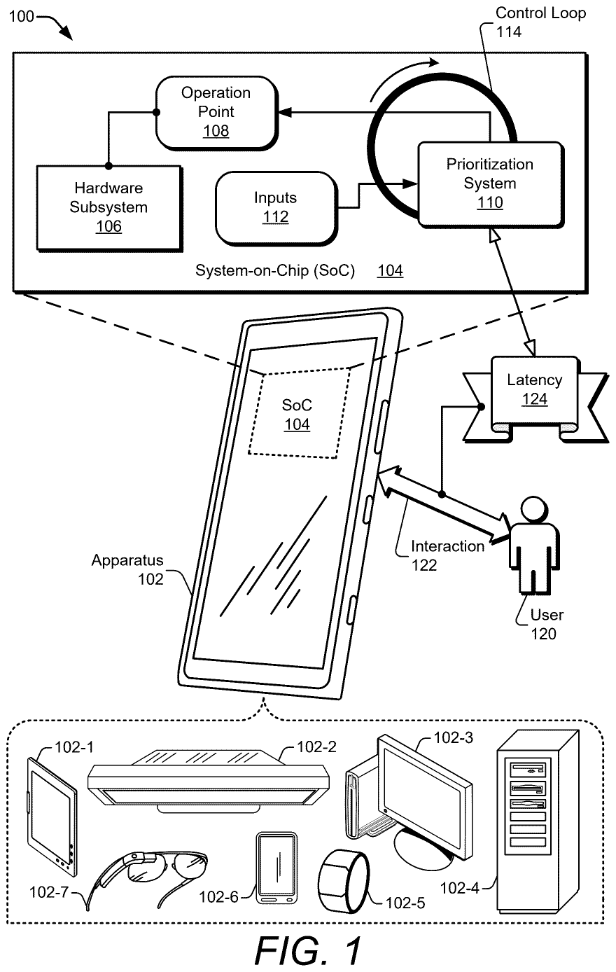

FIG. 1 illustrates a high-level overview of an example environment 100 for implementing hierarchical workload-driven control of dynamic operation-point adjustments. The environment 100 can provide a conceptual foundation for balancing, for example, device performance against power and thermal constraints during user interactions with applications and other workloads. As shown, an example apparatus 102 includes a system-on-chip (SoC) 104. The SoC 104 includes a hardware subsystem 106. A prioritization system 110 is depicted as managing an operation point 108 that is applied to the hardware subsystem 106. At least one control loop 114, which may be part of the prioritization system 110, is configured to evaluate one or more inputs 112 to provide signaling (e.g., candidate operation points) as part of the prioritization system 110. FIG. 1 further depicts a user 120 engaged in an interaction 122 with the apparatus 102. This interaction 122 results in a latency 124 between when the user 120 enters a command and when the apparatus 102 presents a response. The apparatus 102 may be realized as any of a variety of electronic devices, which are described below.

In example implementations, the prioritization system 110 can operate as a dynamic framework to reduce the end-to-end latency 124 experienced by the user 120 while balancing the impacts on the SoC 104 or other hardware. Physically and logically, a workload executing on the apparatus 102 utilizes the resources of the hardware subsystem 106 of the SoC 104 to respond to commands (e.g., prompts or queries) delivered by the user 120 during the interaction 122. The prioritization system 110, including the control loop 114, may be interrelated with these components to analyze the state of the hardware subsystem 106 and the nature of the interaction 122 via the inputs 112 to produce an appropriate operation point 108 for the hardware subsystem 106. This operation point 108 may establish physical operating conditions for the hardware subsystem 106, like a specific target voltage value or a specific target frequency level.

By dynamically arbitrating between multiple candidate operation points to adjust these physical operating conditions, the prioritization system 110 can ensure that the apparatus 102 maintains a high level of performance while adhering to various constraints, like thermal thresholds, power limits, or long-term reliability boundaries. A resulting benefit of this arrangement is an appreciable reduction in the latency 124, especially during high-demand computational tasks, like those associated with sudden, bursty workloads. This approach can avoid the pitfalls of relying solely on reactive power and thermal mitigation mechanisms or static operating caps that might otherwise cause the hardware subsystem 106 to be throttled prematurely or to respond too slowly to sudden workload demands. Consequently, the performance of the apparatus 102 is more responsive and reliable across a spectrum of different workloads.

In the illustrated example, the apparatus 102 is depicted as a smartphone. The apparatus 102 may, however, be implemented as any suitable computing or other electronic device as described herein. Examples of the apparatus 102 include a mobile electronic device or mobile device, mobile communication device, modem, cellular or mobile phone, mobile station, gaming device, navigation device, media or entertainment device (e.g., a media streamer or gaming controller), laptop computer, desktop computer, tablet computer, smart appliance, vehicle-based electronic system, wearable computing device (e.g., clothing, watch, reality-altering glasses, or AI assistant), Internet of Things (IoTs) device, sensor, stock management device, electronic portion of a machine or piece of equipment (e.g., a vehicle or robot), memory storage device (e.g., a solid-state drive (SSD)), server computer or portion thereof (e.g., a server blade or rack or another part of a datacenter), medical device, and the like. Illustrated examples of the apparatus 102 include a tablet device 102-1, a smart television 102-2, a desktop computer 102-3, a server computer 102-4, a smartwatch 102-5, a smartphone (or document reader) 102-6, and intelligent glasses 102-7 (e.g., virtual-or mixed-reality glasses).

### Example Apparatuses and Operational Schemes

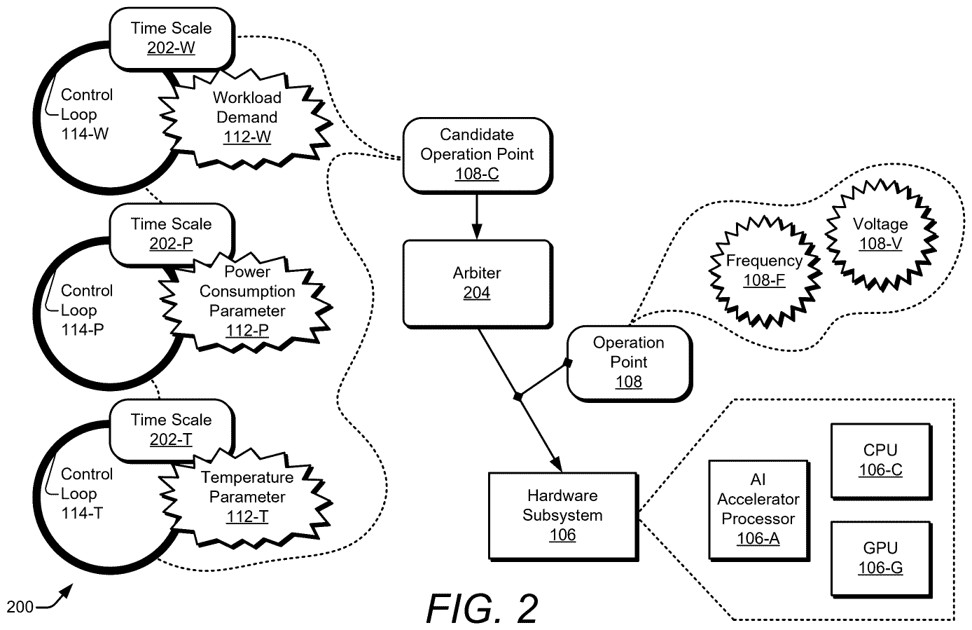

FIG. 2 illustrates an example multi-control-loop environment 200 that can operate at different time scales to provide hierarchical workload-driven control of dynamic operation-point adjustments. As shown, the environment 200 includes at least one arbiter 204, the multiple inputs 112, the at least one operation point 108, and the hardware subsystem 106. The operation point 108 can include a voltage 108-V or a frequency 108-F. The hardware subsystem 106 can include or be realized with an artificial intelligence (AI) accelerator processor 106-A, a central processing unit (CPU) 106-C, a graphics processing unit (GPU) 106-G, a security subsystem, a memory controller, an interconnect, a modem, another circuit that operates with an adjustable voltage or frequency, and so forth.

Continuing with the description of FIG. 2, the environment 200 also includes multiple specific example instances of the control loop 114 and the inputs 112 in conjunction with respective time scales 202. These include a workload-related control loop 114-W operating at a workload time scale 202-W and in response to a workload demand 112-W. These control-loop instances also include a power-related control loop 114-P operating at a power time scale 202-P and in response to a power consumption parameter 112-P. The depicted example instances further include a temperature-related control loop 114-T operating at a temperature time scale 202-T and in response to a temperature parameter 112-T. The control loops 114-W, 114-P, and 114-T and the arbiter 204 can be part of the prioritization system 110 (e.g., of FIG. 1).

In example implementations, the environment 200 decouples proactive, high-speed workload-driven performance scaling from reactive, slower-speed physical constraint scaling. The control loop 114-W evaluates the workload demand 112-W at the workload time scale 202-W to generate a first candidate operation point (not shown in FIG. 2, but see FIGS. 3, 5, 5-1, and 5-2). The workload demand 112-W can include application-provided metadata, like a target workload completion time, an explicit minimum frequency requirement, a quality-of-service (QoS) hint, combinations thereof and so forth. This workload demand 112-W is different from a measured processing load or hardware utilization metrics. The time scale 202-W is generally faster, like a microsecond scale, than the power time scale 202-P or the temperature time scale 202-T.

The control loop 114-P evaluates the power consumption parameter 112-P at the power time scale 202-P to generate a second candidate operation point (not shown in FIG. 2, but see FIGS. 3, 5, 5-1, and 5-2). The control loop 114-T evaluates the temperature parameter 112-T at the temperature time scale 202-T to generate another candidate operation point (not shown in FIG. 2). These relatively slower control loops can manage the physical boundaries and constraints of the hardware subsystem 106. It should be understood that if a temperature-related control loop 114-T is implemented, including but not limited to in the absence of a power-related control loop 114-P, the temperature-related control loop 114-T can generate a second candidate operation point.

In some cases, the arbiter 204 receives multiple candidate operation points 108-C from the multiple control loops 114-W, 114-P, and 114-T. The arbiter 204 arbitrates between these provided candidate operation points 108-C to select an operation point 108 as an execution operation point 108. The selected execution operation point 108 establishes the frequency 108-F or the voltage 108-V that is applied to the hardware subsystem 106. By evaluating candidate operation points 108-C, which may arrive at different cadences due to the different time scales 202, the arbiter 204 can proactively prioritize rapid workload demands 112-W over slower reactive physical constraints. This prioritization can limit execution latency, including but not limited to the latency of bursty tasks. As described herein, this control architecture is highly modular and can be instantiated independently per hardware subsystem 106. Thus, an apparatus 102 can independently execute instances of the control loops 114-W, 114-P, and 114-T and the arbiter 204 for the CPU 106-C, while independently executing separate instances for the GPU 106-G or the AI accelerator processor 106-A.

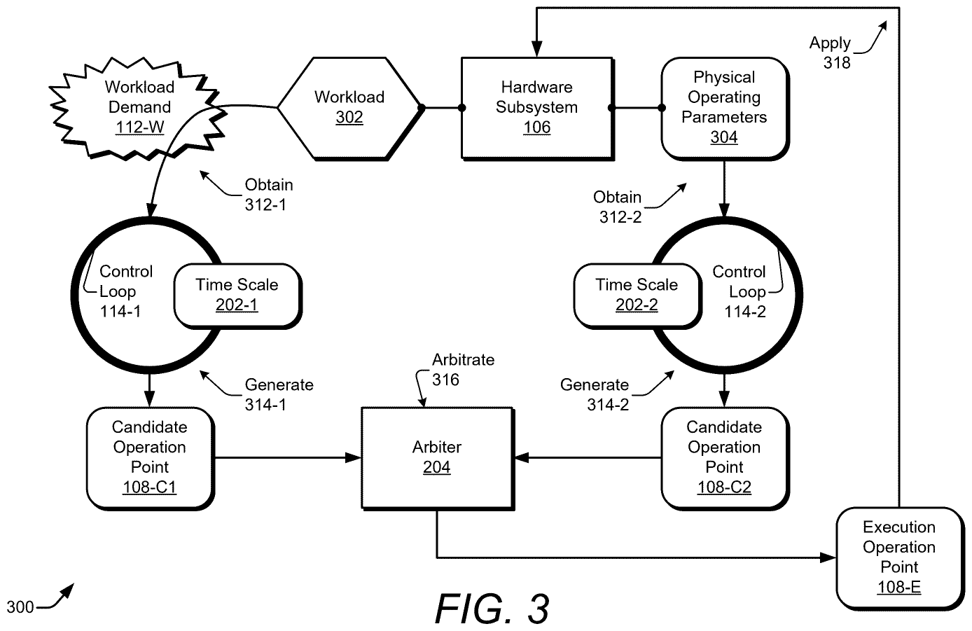

FIG. 3 illustrates, generally at 300, example prioritization systems that can implement hierarchical workload-driven control of dynamic operation-point adjustments using multiple control loops 114 and at least one arbiter 204. As shown, the scheme includes a workload 302 executing on a hardware subsystem 106, at least one workload demand 112-W, and one or more physical operating parameters 304. FIG. 3 also depicts, on the left, an obtain 312-1 operation, a first control loop 114-1 that is operating at a first time scale 202-1, a generate 314-1 operation, and a first candidate operation point 108-C1. On the right, FIG. 3 also depicts an obtain 312-2 operation, a second control loop 114-2 that is operating at a second time scale 202-2, a generate 314-2 operation, and a second candidate operation point 108-C2. The arbiter 204 is illustrated receiving multiple candidate operation points 108-C, like the first candidate operation point 108-C1 and the second candidate operation point 108-C2, to perform an arbitrate 316 operation. As a result of the arbitrate 316 operation, the arbiter 204 outputs an execution operation point 108-E. The scheme also shows an apply 318 operation that provides the execution operation point 108-E to the hardware subsystem 106.

In example implementations, an apparatus utilizes a prioritization system to decouple proactive performance scaling from reactive physical-constraint scaling. To do so, the apparatus performs the obtain 312-1 operation to obtain at least one workload demand 112-W associated with the workload 302 executing on the hardware subsystem 106. The first control loop 114-1 performs the generate 314-1 operation to generate the first candidate operation point 108-C1 based on the at least one workload demand 112-W at the first time scale 202-1. Separately, the apparatus performs the obtain 312-2 operation to obtain one or more physical operating parameters 304 associated with the hardware subsystem 106. The second control loop 114-2 performs the generate 314-2 operation to generate the second candidate operation point 108-C2 based on the one or more physical operating parameters 304 at the second time scale 202-2. Here, the second time scale 202-2 is slower than the first time scale 202-1.

With multiple candidate operation points 108-C generated, the arbiter 204 performs the arbitration 316 operation to arbitrate between the multiple candidate operation points 108-C, including at least the first candidate operation point 108-C1 and the second candidate operation point 108-C2, to select the execution operation point 108-E. As used herein, arbitrating “between” multiple items can include selecting from two, three, four, or more items, like candidate operation points 108-C. This arbitrating includes prioritizing the first candidate operation point 108-C1 over the second candidate operation point 108-C2 to proactively satisfy workload demands 112-W. The apparatus then performs the apply 318 operation to apply the execution operation point 108-E to the hardware subsystem 106 to change, for example, the frequency 108-F or the voltage 108-V of operation.

In some cases, the arbiter 204 is part of the prioritization system 110 (e.g., of FIG. 1). Further, the first control loop 114-1 may be realized as a workload control loop 114-W. Conversely, the second control loop 114-2 may be realized as a power control loop 114-P, a thermal control loop 114-T, a reliability control loop, and so forth. A system may also implement more than two control loops 114. As used herein, an “operation point 108” can represent or correspond to, depending on context, a first candidate operation point 108-C1, a second candidate operation point 108-C2, an execution operation point 108-E, an applied operation point, and so forth. Each operation point 108 can include, for example, a target voltage 108-V, a target frequency 108-F, and so forth in a DVFS context.

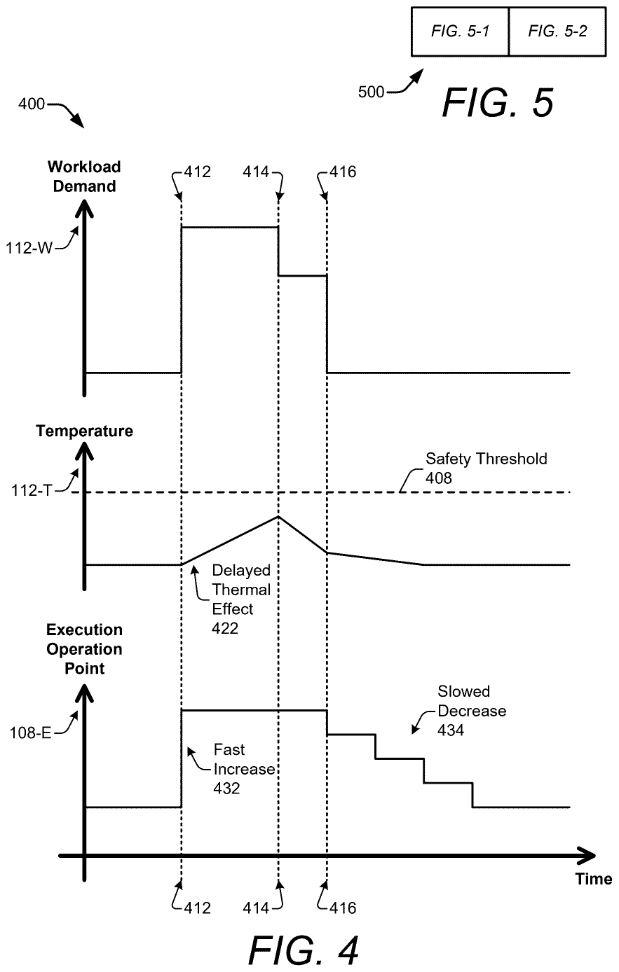

FIG. 4 depicts an example diagram 400 including three graphs with a common time axis to illustrate example prioritization control aspects of hierarchical workload-driven control of dynamic operation-point adjustments. The horizontal axis represents elapsed time. As shown, an upper graph includes a trace for the workload demand 112-W. A middle graph includes a trace for a temperature 112-T relative to a safety threshold 408 and a delayed thermal effect 422. A lower graph includes a trace for the execution operation point 108-E that depicts a fast increase 432 and a slowed decrease 434. The common horizontal time axis is marked with three example time indices: a time index 412, a time index 414, and a time index 416.

In example implementations, the timing diagram 400 illustrates asymmetric scaling for operation-point adjustments utilizing a generous-up and conservative-down methodology. At the time index 412, the workload demand 112-W experiences a sudden spike. To capture this bursty workload, a workload-related control loop generates an increased first candidate operation point based on an upward operation point adjustment (e.g., without applying a filtering profile or without applying a filtering profile that reduces a rate of change). This unfiltered scaling results in the fast increase 432 of the execution operation point 108-E. Conversely, when the workload demand 112-W drops at the time index 414 and again at the time index 416, the workload-related control loop applies a filtering profile to a downward operation point adjustment to slow the decrease. The filtering profile applies filtering such that a sustained downward trend occurs prior to generating a reduced first candidate operation point. This produces the slowed decrease 434, which ensures the device does not throttle performance prematurely (e.g., if another burst closely follows). In some cases, respective individual control loops can filter their own computations internally before offering a candidate operation point to an arbiter for analysis and selection.

In some implementations, the timing diagram 400 further illustrates a predictive thermal bypass, which can operate as an exception to strict physical constraints (e.g., at a microsecond time scale). At the time index 412, the fast increase 432 proposes an aggressive execution operation point 108-E that would mathematically violate the safety threshold 408 in a steady-state scenario. An arbiter could override the prioritizing of the first candidate operation point, which is based on the workload demand, over the second candidate operation point, which is based on thermal parameters, due to the safety threshold 408 likely being violated. However, an arbiter can instead generate, using a predictive thermal model, a prediction of expected temperature behavior for the hardware subsystem based on the first candidate operation point. If the prediction of expected temperature behavior indicates that no violation of the safety threshold 408 over a duration of the workload (e.g., between the time index 412 and the time index 414) will occur, the arbiter bypasses the overriding. This bypassing occurs, for instance, based on the duration of the workload being shorter than a time period over which the physical thermal effect, like the climbing of the delayed thermal effect 422, would be observable in response to applying to the hardware subsystem the first candidate operation point as the execution operation point 108-E. Consequently, the temperature 112-T safely peaks after the workload finishes and remains below the safety threshold 408.

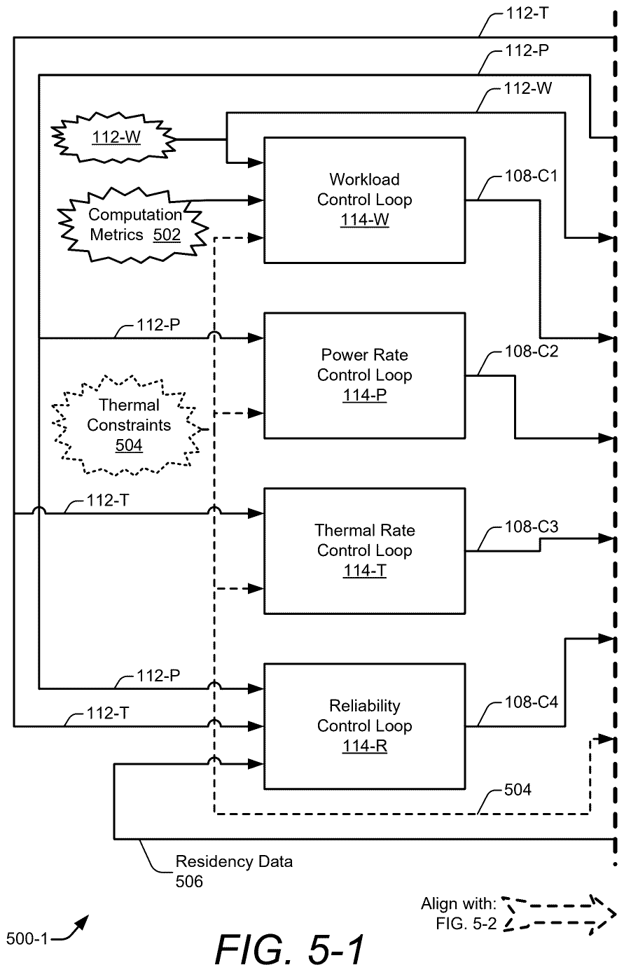

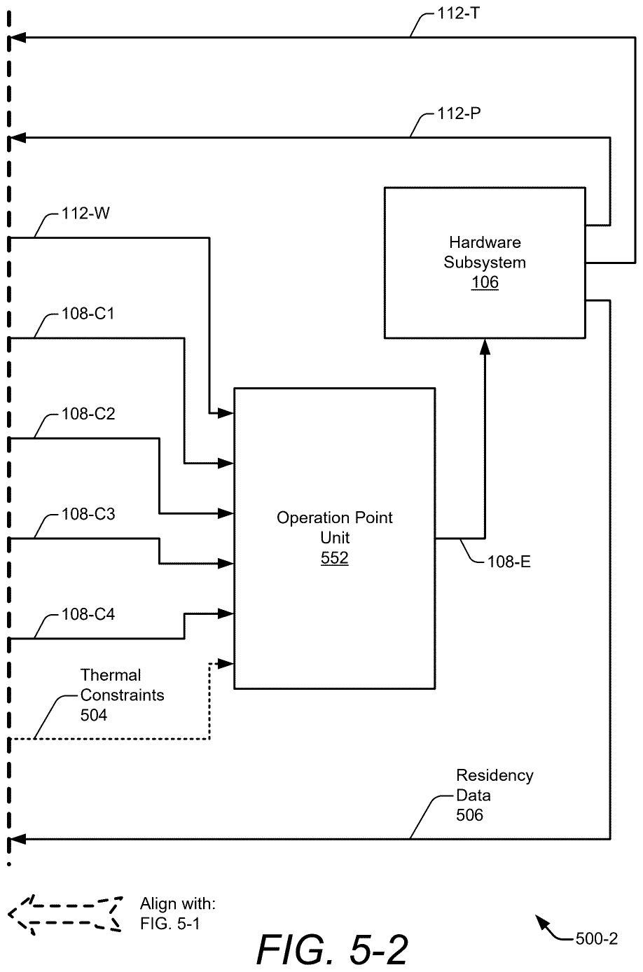

FIGS. 5, 5-1, and 5-2 illustrate other example prioritization systems that can implement hierarchical workload-driven control of dynamic operation-point adjustments using multiple example control loops, an operation point unit, and multiple signaling examples. As shown, FIG. 5 provides an example map depicting how a first portion 500-1 of FIG. 5-1 aligns with a second portion 500-2 of FIG. 5-2 to form a full schematic architecture. As shown across the two sheets, the first portion 500-1 includes various inputs like at least one workload demand 112-W, one or more computation metrics 502, at least one power consumption parameter 112-P, one or more thermal constraints 504, at least one temperature parameter 112-T, and residency data 506. For clarity, the thermal constraints 504 are depicted with a small-dashed line. Also depicted in the first portion 500-1 are four control loops 114, including a workload control loop 114-W, a power rate control loop 114-P, a thermal rate control loop 114-T, and a reliability control loop 114-R.

These four control loops respectively output a first candidate operation point 108-C1, a second candidate operation point 108-C2, a third candidate operation point 108-C3, and a fourth candidate operation point 108-C4. These four candidate operation points 108-C1 to 108-C4 cross the boundary between drawing sheets to the second portion 500-2 of FIG. 5-2. On the second portion 500-2, at least one operation point unit 552 receives these four candidate operation points 108-C1 to 108-C4 in addition to the thermal constraints 504 and the workload demand 112-W. The operation point unit 552 outputs an execution operation point 108-E to a hardware subsystem 106 to change the operation thereof. Multiple “feedback” signals route from the second portion 500-2 “back” to the first portion 500-1. These feedback signals include the power consumption parameter 112-P, the temperature parameter 112-T, and the residency data 506.

In some example implementations, an apparatus utilizes the interconnected modules across FIG. 5-1 and FIG. 5-2 to concurrently process different physical and computational variables. Generally, a first control loop 114-1 may be realized as the workload control loop 114-W. A second control loop 114-2, on the other hand, may be realized interchangeably, or concurrently, as the power rate control loop 114-P, the thermal rate control loop 114-T, the reliability control loop 114-R, and so forth. In some cases, specific computational operations related to power tiers, thermal safety, reliability integration, target performance criteria evaluations, and so forth occur internally within these respective control blocks shown in the first portion 500-1.

In some implementations, the workload control loop 114-W acts as a first performance detection loop operating at a first time scale to quickly capture application demands. To do so, the workload control loop 114-W obtains at least one workload demand 112-W to determine at least one target performance criterion. To prevent wasteful scaling, the workload control loop 114-W can perform a plausibility check using the computation metrics 502. The workload control loop 114-W evaluates whether a proposed operation point can satisfy the at least one target performance criterion in view of the computation metrics 502 to generate the first candidate operation point 108-C1. The computation metrics 502 can include measured, hardware-generated telemetry data. Examples of hardware-generated telemetry data include, for example, a run-queue occupancy, an instruction-per-cycle (IPC) degradation metric, a cache-access rate, a pipeline-stall behavior, a wake-up event, an interrupt arrival, and so forth. Although not shown, the workload control loop 114-W may also operate based on the current frequency of one or more subsystems, including that of the hardware subsystem 106.

As an example evaluation, if the computation metrics 502 indicate that increasing a clock frequency will not improve performance due to external bandwidth bottlenecks, the workload control loop 114-W adjusts the generation of the candidate operation point 108-C1 accordingly. For instance, the workload control loop 114-W can delay requesting a higher operational frequency until the external bandwidth bottleneck resolves. The apparatus can also run multiple concurrent performance detection loops for a single hardware subsystem 106. For example, a second performance detection loop configured for sustained workloads can operate concurrently with a workload control loop 114-W configured for bursty workloads to generate an extra candidate operation point or a combined candidate operation point.

In some cases, to further manage the generation of the first candidate operation point 108-C1, the workload control loop 114-W can apply disparate filtering based on the direction of an adjustment. For example, to help ensure that operation-point scaling does not become a performance bottleneck for bursty tasks, increasing operation-point requests may remain unfiltered. On the other hand, the workload control loop 114-W may filter a downward operation-point adjustment using, e.g., a single pole lowpass filter having a tunable time constant to impede the downward adjustment.

In some implementations, the power rate control loop 114-P manages physical limits at a second, slower time scale. The power rate control loop 114-P obtains the power consumption parameter 112-P. In example operations, the power rate control loop 114-P can filter the power consumption parameter 112-P over a sliding time window to generate a power consumption envelope. This filtering may apply, for instance, an exponential moving average to isolate a sustained computational demand from transient power bursts. The power rate control loop 114-P then compares the power consumption envelope to multiple predefined power tiers and adjusts the second candidate operation point 108-C2 based on the comparison. To maintain stability, the power rate control loop 114-P may enforce a hysteresis buffer between adjacent power tiers of the multiple predefined power tiers to prevent oscillatory operation-point transitions.

In some cases, the power rate control loop 114-P can provide a short-term estimate of workload intensity and execution efficiency for the hardware subsystem 106. The power rate control loop 114-P can analyze rapid hardware-subsystem power-consumption fluctuations to distinguish between sustained computational demand and transient bursts. This enables precise frequency or voltage control to address ongoing workload conditions without interfering with the faster, performance-driven workload demands. To do so, the power rate control loop 114-P may regulate the operation point 108 during sustained execution by defining utilization windows for each available operation point 108. When a power consumption rate exceeds or falls below predefined bounds, the power rate control loop 114-P can incrementally adjust the second candidate operation point 108-C2 to avoid over-utilization for workloads that do not heavily utilize the hardware subsystem 106. This power-based tuning can be performed while preserving a capacity to respond quickly to bursts. The power rate control loop 114-P can contribute to balancing hardware-subsystem energy efficiency, thermal safety, and workload-adaptive performance.

In some implementations, the thermal rate control loop 114-T also manages physical limits at a second, slower time scale, which may be the same as or different than that of the power rate control loop 114-P. Concurrently or at different times, the thermal rate control loop 114-T can evaluate a rate of change of the temperature parameter 112-T in view of the thermal constraints 504 to generate the third candidate operation point 108-C3. The thermal rate control loop 114-T can monitor long-term temperature trends across different time scales and factor in the sustainability of long-term hardware-subsystem performance. As reflected in the signaling depicted in FIG. 5-1, the workload control loop 114-W or the power rate control loop 114-P can also generate respective candidate operation points 108-C1 or 108-C2 based on the thermal constraints 504.

In some cases, to generate the third candidate operation point 108-C3, the thermal rate control loop 114-T may employ significant filtering at varying time scales to emphasize temperature trends instead of instantaneous fluctuations in the temperature parameter 112-T. By tracking these trends, the thermal rate control loop 114-T can limit how long a high-performance operation point 108 can be sustained to prevent thermal runaway and excessive throttling cycles. In example operations, the thermal rate control loop 114-T avoids preventing upward operation-point transitions initiated by performance demands unless the thermal constraints 504 are violated. Consequently, the thermal rate control loop 114-T can reduce oscillatory mitigation, support bursty execution, and help maintain stable execution while incorporating safe thermal limits.

In some implementations, the reliability control loop 114-R operates at a macro time scale that is significantly slower than the other loops to manage hardware preservation over an expected multi-year lifespan. The reliability control loop 114-R obtains the residency data 506 to track a respective residency duration for each of multiple historical operation points 108 of the hardware subsystem 106. The reliability control loop 114-R can apply a stress weight to each historical operation point 108 of the multiple historical operation points 108 based on an associated historical voltage or an associated historical temperature reported via the power consumption parameter 112-P and the temperature parameter 112-T. This stress weight can correspond to a physical silicon-degradation model, and the reliability control loop 114-R can scale the stress weight non-linearly. In example operations, the reliability control loop 114-R can compute long-term cumulative operational-stress data by integrating the stress weight of each historical operation point over the corresponding respective residency duration. Based on these computations, the reliability control loop 114-R outputs the fourth candidate operation point 108-C4.

In some cases, rather than aggressively avoiding high target frequencies that could degrade the processing experience, the reliability control loop 114-R may influence the hardware subsystem 106 indirectly. For instance, the reliability control loop 114-R can apply slow, step-limited transitions to the fourth candidate operation point 108-C4 based on the integrated stress weights.

In some implementations, the operation point unit 552 includes or operates like an arbiter 204. To do so, the operation point unit 552 can perform an operation of arbitrating between multiple candidate operation points 108-C to select the execution operation point 108-E. The operation point unit 552 proactively prioritizes the workload-driven first candidate operation point 108-C1 over the others, subject to safety evaluations using, e.g., the thermal constraints 504. Further, if the long-term cumulative operational-stress data computed internally by the reliability control loop 114-R exceeds a target degradation threshold associated with the expected multi-year lifespan of the hardware subsystem 106, the operation point unit 552 can apply a progressive bias in favor of one or more down-scaling decisions. Alternatively, the operation point unit 552 can enforce a maximum available operation-point cap by selecting the fourth candidate operation point 108-C4.

Generally, the operation point unit 552 may alternatively implement a relatively straightforward selection process. For example, the operation point unit 552 may enforce the “minimum” of the candidate frequencies to guarantee thermal constraints are met or the “maximum” of the candidates to be highly ambitious about performance. Although not shown, the operation point unit 552 may also operate based on a thermal model, including a predictive thermal model as described herein.

In some cases, during the selection of the execution operation point 108-E, the operation point unit 552, acting as the arbiter 204, can also apply hysteresis or stability criteria. This arbiter-level stability evaluation prevents oscillatory behavior at the hardware subsystem 106 across the competing control loops, yielding a workload-driven, safe, and efficient selection for the execution operation point 108-E. To enact the selected operation point 108, the execution operation point 108-E is applied to the hardware subsystem 106. This generates new or updated physical operating parameters 304 that are routed to the control loops 114 as feedback to continuously drive the dynamic operation-point adjustments.

Having generally described schemes, techniques, and hardware for implementing hierarchical workload-driven control of dynamic operation-point adjustments, this discussion now turns to example methods.

### Example Methods

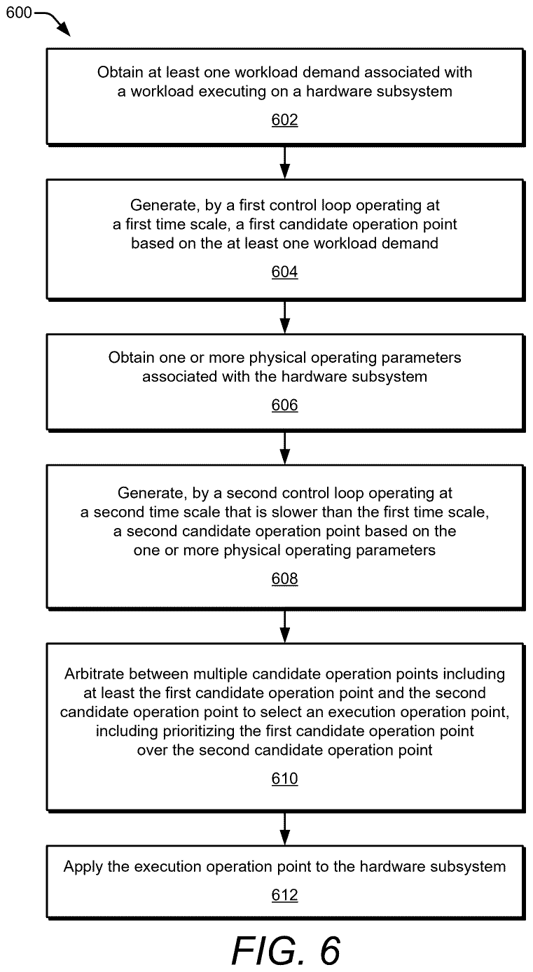

FIG. 6 is a flow diagram 600 illustrating example processes for hierarchical workload-driven control of dynamic operation-point adjustments. The flow diagram 600 includes six blocks 602-612. In example implementations, the operations of the flow diagram 600 may be performed by an apparatus 102; a prioritization system 110, including an arbiter 204 or an operation point unit 552 thereof; and so forth.

At block 602, at least one workload demand associated with a workload executing on a hardware subsystem is obtained. For example, an apparatus 102 can obtain at least one workload demand 112-W associated with a workload 302 executing on a hardware subsystem 106. In some cases, the apparatus 102 may retrieve application-provided metadata that represents (e.g., defines or specifies) the at least one workload demand 112-W. For instance, this metadata may include an explicit minimum frequency requirement, a quality-of-service (QoS) hint, or a target workload completion time. Thus, the prioritization system 110 may operate based on actual, latency-sensitive application performance goals.

At block 604, a first candidate operation point is generated by a first control loop operating at a first time scale based on the at least one workload demand. For example, a first control loop 114-1 operating at a first time scale 202-1 can generate a first candidate operation point 108-C1 based on the at least one workload demand 112-W. This generation may be performed by a workload control loop 114-W operating at a microsecond time scale to quickly evaluate the at least one workload demand 112-W. To do so, the workload control loop 114-W may perform a plausibility check against hardware-generated computation metrics 502, like a cache-access rate or pipeline-stall behavior, to ensure a proposed operation point 108 could actually satisfy a target performance criterion before generating the first candidate operation point 108-C1. Thus, the first control loop 114-1 may proactively propose an aggressive target frequency for sudden computational bursts that will not waste power if the computation metrics 502 do not indicate the presence of a bottleneck that is separate from a processing frequency. Generating can include, for example, computing, determining algorithmically or using a machine-learned (ML) model, calculating, adjusting from a baseline or previous setting, selecting from a set of values, mapping an input to an output using a lookup table (LUT), combinations thereof, and so forth.

At block 606, one or more physical operating parameters associated with the hardware subsystem are obtained. For example, the apparatus 102 can obtain one or more physical operating parameters 304 associated with the hardware subsystem 106. Here, the apparatus 102 may gather real-time telemetry representing the physical operating condition of the hardware subsystem 106. For instance, the apparatus 102 may monitor a power consumption parameter 112-P, a temperature parameter 112-T, or residency data 506 relating to long-term cumulative operational stress of the hardware subsystem 106. Obtaining these parameters separately from the workload demands may enable the architecture to physically protect the silicon independently of the pursuit of computational performance goals.

At block 608, a second candidate operation point is generated by a second control loop operating at a second time scale, which is slower than the first time scale, based on the one or more physical operating parameters. For example, a second control loop 114-2 operating at a second time scale 202-2 that is slower than the first time scale 202-1 can generate a second candidate operation point 108-C2 based on the one or more physical operating parameters 304. In some cases, this generation may be performed by a power rate control loop 114-P filtering the power consumption parameter 112-P over a sliding time window to isolate a sustained computational demand from transient power bursts. Additionally or alternatively, a thermal rate control loop 114-T may evaluate a rate of change of the temperature parameter 112-T, or a reliability control loop 114-R may evaluate long-term cumulative operational-stress data based on historical residency durations as a third control loop operating at a third time scale or a fourth control loop operating at a fourth time scale. Thus, generating one or more candidate operation points 108-C at these slower, independent time scales may ensure rigorous, long-term hardware preservation without unnecessarily hindering transient burst performance.

At block 610, arbitration between multiple candidate operation points, including at least the first candidate operation point and the second candidate operation point, is performed to select an execution operation point, including by prioritizing the first candidate operation point over the second candidate operation point. For example, an arbiter 204 can arbitrate between multiple candidate operation points 108-C including at least the first candidate operation point 108-C1 and the second candidate operation point 108-C2 to select an execution operation point 108-E. This arbitration can include prioritizing the first candidate operation point 108-C1 over the second candidate operation point 108-C2. To do so, an operation point unit 552 may favor the proactive, workload-driven candidate operation point 108-C1 if the thermal constraints 504 are satisfied. In some cases, the operation point unit 552 may override this prioritization if selection of the first candidate operation point 108-C1 would violate a safety threshold 408, unless a predictive thermal bypass determines a burst duration will be shorter than a time period that transpires before observing a sufficiently negative physical thermal effect. Here, this smart arbitration may substantially decrease execution latency 124 for bursty workloads while safely enforcing absolute physical boundaries.

At block 612, the execution operation point is applied to the hardware subsystem. For example, the apparatus 102 can apply the execution operation point 108-E to the hardware subsystem 106. Thus, the hardware subsystem 106 may shift its processing speed and power draw to match a newly established target voltage 108-V or target frequency 108-F. The resulting physical operating parameters 304 associated with the hardware subsystem 106 may then loop back into the prioritization system 110 to drive continuous dynamic operation-point adjustments.

In some implementations of a process in accordance with the flow diagram 600, the apparatus 102 may independently execute an instance of the first control loop 114-1, an instance of the second control loop 114-2, and an instance of the arbitrating between the multiple candidate operation points 108-C by the arbiter 204 for a second hardware subsystem of the SoC 104.

Aspects of these methods may be implemented in, for example, hardware (e.g., fixed logic circuitry, a controller, a finite state machine, or a processor in conjunction with a memory), firmware, software, or some combination thereof. The methods may be realized to produce one or more of the apparatuses or components shown in FIGS. 1 to 5-2 and 7, which components may be further divided, combined, and so on. The devices and components of these figures generally represent hardware, like electronic devices, PCBs, packaged modules, IC chips, components, or circuits; firmware; software; or a combination thereof. Thus, these figures illustrate some of the many possible systems or apparatuses capable of being produced using the described methods.

For the methods described herein and the associated flow chart(s) and/or flow diagram(s), the orders in which operations are shown and/or described are not intended to be construed as a limitation. Instead, any number or combination of the described method operations can be combined in any order to implement a given method or an alternative method, including by combining operations from different ones of the flow chart(s) and flow diagram(s) and the earlier-described schemes and techniques into one or more methods. Operations may also be omitted from or added to the described methods. Further, described operations can be implemented in fully or partially overlapping manners.

### Additional Example Apparatuses and Electronic Devices

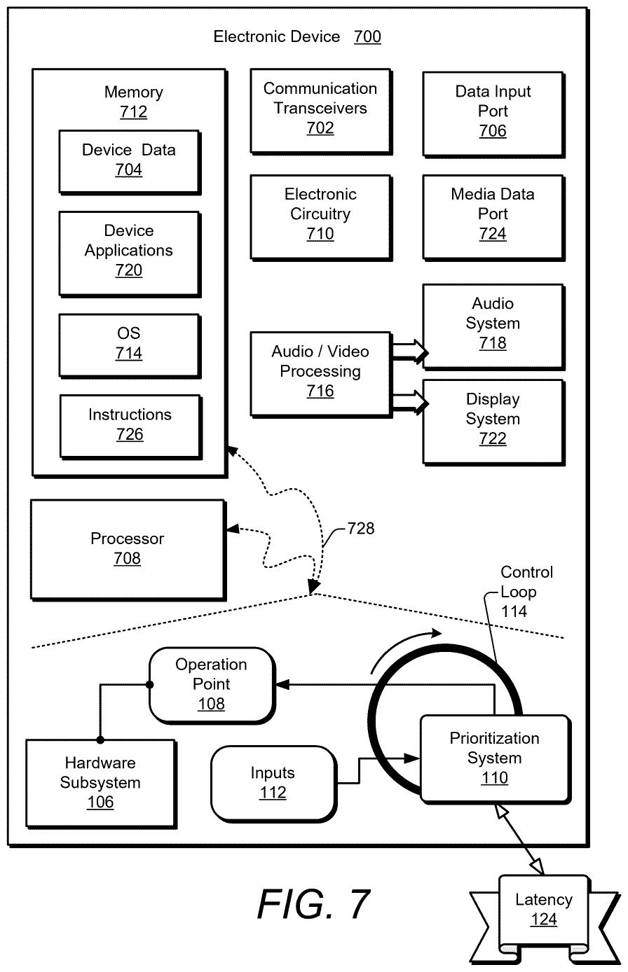

FIG. 7 illustrates various components of an example electronic device 700 that can implement hierarchical workload-driven control of dynamic operation-point adjustments in accordance with one or more described aspects. The electronic device 700 may be implemented as any one or combination of a fixed, mobile, stand-alone, or embedded device or in any form of a consumer, computer, portable, user, server, communication, phone, navigation, gaming, audio, camera, messaging, media playback, and/or other type of electronic device 700, like the smartphone that is depicted in FIG. 1 as the apparatus 102. One or more of the illustrated components may be realized as discrete components or as integrated components on at least one integrated circuit of the electronic device 700 or separately or jointly in one or more packages of the electronic device 700.

In some cases, the electronic device 700 can include one or more communication transceivers 702 that enable wired and/or wireless communication of device data 704, like received data, transmitted data, or other information identified above. Communication transceivers 702 can include, by way of example but not limitation, near-field communication (NFC) transceivers, wireless personal area network (PAN) (WPAN) radios compliant with various IEEE 802.15 (Bluetooth®) standards, wireless local area network (LAN) (WLAN) radios compliant with any of the various IEEE 802.11 (Wi-Fi®) standards, wireless wide area network (WAN) (WWAN) radios (e.g., those that are 3GPP-compliant) for cellular telephony, wireless metropolitan area network (MAN) (WMAN) radios compliant with various IEEE 802.16 (WiMAX™) standards, infrared (IR) transceivers compliant with an Infrared Data Association (IrDA) protocol, and wired local area network (LAN) (WLAN) Ethernet transceivers. A communication transceiver 702 can, however, comport with one or more other wireless standards or protocols.

The electronic device 700 may also include one or more data input ports 706 via which any type of data, media content, and/or other inputs can be received, like user-selectable inputs, messages, applications, music, television content, recorded video content, and any other type of audio, video, and/or image data received from any content and/or data source, including a sensor like a microphone or a camera. The data input ports 706 may include USB ports, coaxial cable ports, fiber optic ports for optical fiber interconnects or cabling, and other serial or parallel connectors (including internal connectors) for flash memory, DVDs, CDs, and the like. These data input ports 706 may be used to couple the electronic device to components, peripherals, or accessories like keyboards, microphones, cameras, or other sensors.

The electronic device 700 of this example includes one or more processors 708 (e.g., any one or more of application processors, microprocessors, digital-signal processors (DSPs), controllers, and the like), which can include a combined processor and memory system (e.g., implemented as part of an SoC), that execute (e.g., process or otherwise implement) processor-executable instructions 726 (e.g., computer-executable instructions) to control operation of the device. The processor 708 may be implemented as an application processor, embedded controller, microcontroller, security processor, artificial intelligence (AI) accelerator, and the like. Generally, a processor or processing system may be implemented at least partially in hardware, which can include components of an integrated circuit or on-chip system, a digital signal processor (DSP), an application-specific integrated circuit (ASIC), a field programmable gate array (FPGA), a complex programmable logic device (CPLD), and other implementations in silicon and/or other materials.

Alternatively or additionally, the electronic device 700 can be implemented with any one or combination of electronic circuitry, which may include software, hardware, firmware, or fixed logic circuitry that is implemented in connection with processing and control circuits, which are generally indicated at 710 (as electronic circuitry 710). This electronic circuitry 710 can implement executable or hardware-based modules (not shown in FIG. 7), like through processing/computer-executable instructions stored on computer-readable media, through logic circuitry and/or hardware (e.g., an FPGA), and so forth.

The electronic device 700 can include a system bus, interconnect, crossbar, data transfer system, switch fabric, or other communication fabric that couples the various components within the device. A system bus or interconnect can include any one or a combination of different bus structures, like a memory bus or memory controller, a peripheral bus, a universal serial bus (USB), and/or a processor or local bus that utilizes any of a variety of bus architectures.

The electronic device 700 also includes at least one memory 712 (e.g., one or more memory devices 712) that enables data storage, examples of which include random-access memory (RAM), non-volatile memory (e.g., read-only memory (ROM), flash memory, EPROM, and EEPROM), and a disk storage device. Thus, the at least one memory 712 can be distributed across different logical storage levels of a system as well as at different physical components. The memory 712 provides data storage mechanisms to store the processor-executable instructions 726, the device data 704, other types of code and/or data, and various device applications 720 (e.g., software applications or programs). For example, an operating system 714 can be maintained as software instructions within the memory 712 and executed by the processor 708.

In some implementations, the electronic device 700 also includes an audio and/or video processing system 716 that processes audio and/or video data and/or that passes through the audio and/or video data to an audio system 718 and/or to a display system 722 (e.g., a video buffer or a screen of a smartphone or camera). The audio system 718 and/or the display system 722 may include any devices that process, display, and/or otherwise render or present audio, video, display, and/or image data. Display data and audio signals can be communicated to an audio component and/or to a display component via an RF (radio-frequency) link, an S-video link, an HDMI (high-definition multimedia interface) link, a composite video link, a component video link, a DVI (digital video interface) link, an analog audio connection, a video bus, or another similar communication link, like a media data port 724. In some implementations, the audio system 718 and/or the display system 722 are external or separate components of the electronic device 700. Alternatively, the display system 722, for example, can be an integrated component of the example electronic device 700, like part of an integrated touch interface.

The electronic device 700 of FIG. 7 illustrates example implementations of the apparatus 102 of FIG. 1, or of a general apparatus that includes a prioritization system 110 to perform hierarchical workload-driven control of dynamic operation-point adjustments as illustrated in whole or in part across any of the FIGS. 2 to 6, or some combination thereof. Accordingly, one or more of the components illustrated in FIG. 7 may realize or incorporate at least part of other components depicted across the various figures. These other components can include the hardware subsystem 106, the operation point 108, the prioritization system 110, the inputs 112, the control loops 114, and so forth, as well as the modules of FIGS. 5-1 and 5-2. For example, as indicated by arrows 728, the processor 708 may realize at least a portion of the hardware subsystem 106, the prioritization system 110, and one or more instances of the control loop 114.

Additionally or alternatively, the processor 708 may form part of an SoC 104 (not explicitly shown in FIG. 7) of the electronic device 700, with the SoC 104 including the hardware subsystem 106. Other components of FIG. 7, like the communication transceivers 702, may realize a hardware subsystem 106. Further, the memory 712 may store the inputs 112, the operation points 108, the computation metrics 502, the thermal constraints 504, the residency data 506, and other data or the processor-executable instructions 726 utilized by the prioritization system 110 to decrease the latency 124. Thus, the device applications 720 may correspond to the workload 302 that generates a workload demand 112-W, and the device data 704 may include the inputs 112, the operation point 108, the computation metrics 502, the thermal constraints 504, and the residency data 506.

The terms “first,” “second,” “third,” and other numeric-related indicators are used herein to identify or distinguish similar or analogous items from one another within a given context —like a particular implementation, a single drawing figure, or a claim. However, this numbering terminology may differ from context to context or from implementation to implementation. Thus, a first item in one context may differ from a first item in another context. For example, an item identified as a “second control loop” in one context with two control loops may be identified as a “third control loop” in another context with four control loops. As another example, a second control loop may correspond to a power consumption parameter in one context and a temperature parameter in another context.

Features described in the context of one example aspect (e.g., a method or an apparatus) may be used in combination with other example aspects (e.g., an apparatus or a method, respectively, or a different method or a different apparatus).

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, c-c-c, and a-b-b-c, or any other ordering or quantity of a, b, and c). Further, items represented in the accompanying figures and terms discussed herein may be indicative of one or more items or terms, and thus reference may be made interchangeably to single or plural forms of the items and terms in this written description.

Although implementations for realizing hierarchical workload-driven control of dynamic operation-point adjustments have been described in language specific to certain features and/or methods, the subject of the appended claims is not necessarily limited to the specific features or methods described. Rather, the specific features and methods are disclosed as example implementations for hierarchical workload-driven control of dynamic operation-point adjustments.

What is claimed is:

1. An apparatus comprising:
at least one memory comprising processor-executable instructions; and
one or more processors configured to execute the processor-executable instructions to cause the apparatus to perform operations comprising:
obtaining at least one workload demand associated with a workload executing on a hardware subsystem;
generating, by a first control loop operating at a first time scale, a first candidate operation point based on the at least one workload demand;
obtaining one or more physical operating parameters associated with the hardware subsystem;
generating, by a second control loop operating at a second time scale that is slower than the first time scale, a second candidate operation point based on the one or more physical operating parameters;
arbitrating between multiple candidate operation points comprising at least the first candidate operation point and the second candidate operation point to select an execution operation point, including prioritizing the first candidate operation point over the second candidate operation point; and
applying the execution operation point to the hardware subsystem.

2. The apparatus of claim 1, wherein:
the generating of the first candidate operation point comprises applying a filtering profile to a downward operation-point adjustment; and
the filtering profile applies filtering such that a sustained downward trend occurs prior to generating a reduced first candidate operation point.

3. The apparatus of claim 2, wherein the generating of the first candidate operation point further comprises:
generating an increased first candidate operation point based on an upward operation-point adjustment without applying the filtering profile.

4. The apparatus of claim 1, wherein:
the one or more physical operating parameters comprise a power consumption parameter; and
the generating of the second candidate operation point comprises generating the second candidate operation point based on the power consumption parameter.

5. The apparatus of claim 4, wherein the generating of the second candidate operation point comprises:
filtering the power consumption parameter over a sliding time window to generate a power consumption envelope;
comparing the power consumption envelope to multiple predefined power tiers; and
adjusting the second candidate operation point based on the comparing.

6. The apparatus of claim 4, wherein:
the one or more physical operating parameters comprise a temperature parameter;
the one or more processors are further configured to execute the processor-executable instructions to cause the apparatus to perform one or more operations comprising:
generating, by a third control loop operating at a third time scale, a third candidate operation point based on the temperature parameter; and
the arbitrating between the multiple candidate operation points comprises arbitrating between the multiple candidate operation points in which the multiple candidate operation points further comprise the third candidate operation point.

7. The apparatus of claim 1, wherein:
the one or more physical operating parameters comprise a temperature parameter; and
the generating of the second candidate operation point comprises generating the second candidate operation point based on the temperature parameter.

8. The apparatus of claim 7, wherein the generating of the second candidate operation point comprises:
generating the second candidate operation point based on a rate of change of the temperature parameter.

9. The apparatus of claim 1, wherein the at least one workload demand comprises:
application-provided metadata comprising at least one of:
a target workload completion time;
an explicit minimum frequency requirement; or
a quality-of-service (QoS) hint.

10. The apparatus of claim 1, wherein:
the one or more processors are further configured to execute the processor-executable instructions to cause the apparatus to perform one or more operations comprising obtaining one or more computation metrics associated with the hardware subsystem; and
the generating of the first candidate operation point comprises generating the first candidate operation point based on the one or more computation metrics.

11. The apparatus of claim 10, wherein:
the one or more processors are further configured to execute the processor-executable instructions to cause the apparatus to perform one or more operations comprising determining at least one target performance criterion based on the at least one workload demand; and
the generating of the first candidate operation point comprises evaluating whether a proposed operation point satisfies the at least one target performance criterion in view of the one or more computation metrics.

12. The apparatus of claim 10, wherein the one or more computation metrics comprise:
hardware-generated telemetry data comprising at least one of:
a run-queue occupancy;
an instruction-per-cycle (IPC) degradation metric;
a cache-access rate;
a pipeline-stall behavior;
a wake-up event; or
an interrupt arrival.

13. The apparatus of claim 1, wherein the arbitrating between the multiple candidate operation points to select the execution operation point comprises:
determining whether the first candidate operation point violates a safety threshold associated with the one or more physical operating parameters; and
overriding the prioritizing of the first candidate operation point over the second candidate operation point based on the safety threshold being violated.

14. The apparatus of claim 13, wherein the one or more processors are further configured to execute the processor-executable instructions to cause the apparatus to perform one or more operations comprising:
generating, using a predictive thermal model, a prediction of expected temperature behavior for the hardware subsystem based on the first candidate operation point; and
bypassing the overriding of the prioritizing of the first candidate operation point over the second candidate operation point based on the prediction of expected temperature behavior.

15. The apparatus of claim 14, wherein the bypassing of the overriding of the prioritizing of the first candidate operation point over the second candidate operation point based on the prediction of expected temperature behavior comprises:
bypassing the overriding based on the prediction of expected temperature behavior indicating no violation of the safety threshold over a duration of the workload.

16. The apparatus of claim 1, wherein:
the one or more physical operating parameters comprise cumulative operational-stress data of the hardware subsystem; and
the generating of the second candidate operation point comprises generating the second candidate operation point based on the cumulative operational-stress data of the hardware subsystem.

17. The apparatus of claim 1, wherein:
the one or more processors are further configured to execute the processor-executable instructions to cause the apparatus to perform one or more operations comprising generating, by an additional control loop operating at a macro time scale that is slower than the second time scale, an additional candidate operation point based on long-term cumulative operational-stress data of the hardware subsystem; and
the arbitrating between the multiple candidate operation points comprises arbitrating between the multiple candidate operation points in which the multiple candidate operation points further comprise the additional candidate operation point.

18. The apparatus of claim 17, wherein the one or more processors are further configured to execute the processor-executable instructions to cause the apparatus to perform one or more operations comprising:
tracking a respective residency duration for each of multiple historical operation points of the hardware subsystem;
applying a stress weight to each historical operation point of the multiple historical operation points based on at least one of an associated historical voltage or an associated historical temperature; and
calculating the long-term cumulative operational-stress data by integrating the stress weight of each historical operation point over the corresponding respective residency duration.

19. The apparatus of claim 18, wherein the arbitrating between the multiple candidate operation points to select the execution operation point further comprises:
applying a progressive bias in favor of one or more down-scaling decisions or enforcing a maximum available operation-point cap based on the long-term cumulative operational-stress data exceeding a target degradation threshold associated with an expected multi-year lifespan of the hardware subsystem.

20. A method for hierarchical workload-driven control of dynamic operation-point adjustments, the method comprising:
obtaining at least one workload demand associated with a workload executing on a hardware subsystem;
generating, by a first control loop operating at a first time scale, a first candidate operation point based on the at least one workload demand;
obtaining one or more physical operating parameters associated with the hardware subsystem;
generating, by a second control loop operating at a second time scale that is slower than the first time scale, a second candidate operation point based on the one or more physical operating parameters;
arbitrating between multiple candidate operation points comprising at least the first candidate operation point and the second candidate operation point to select an execution operation point, including prioritizing the first candidate operation point over the second candidate operation point; and
applying the execution operation point to the hardware subsystem.
